(19) United States
(12) Patent Application Publication
(10) Pub. No.: US 2004/0024904 A1
(43) Pub. Date: Feb. 5, 2004

(54) Load balancing packet transmission among multiple transmit rings

(76) Inventor: Francesco R. DiMambro, San Jose, CA (US)

Correspondence Address: PARK, VAUGHAN & FLEMING LLP, 702 MARSHALL STREET, SUITE 310, REDWOOD CITY, CA, 94063, US

(21) Appl. No.: 10/210,510

(22) Filed: Jul. 31, 2002

(51) Int. Cl. G06F 15/173

(52) U.S. Cl. 709/238

(57) ABSTRACT

A system and method are provided for using multiple transmit descriptor rings to transmit packets from a computer system. A device driver for a communication interface (e.g., a NIC) receives a packet (e.g., from an upper layer protocol), selects one of the multiple rings and places the packet on the ring. Because the rings are managed in a mutually exclusive manner, packets can be placed on more than one ring at the same time (e.g., by different processors), thus allowing them to be populated in parallel, rather than serially. To select a ring, a packet's destination address, destination port or other characteristic may be hashed, or a modulo of that characteristic over the number of rings may be calculated. Illustratively, all packets in one connection or flow are transmitted through the same ring.

### BACKGROUND

This invention relates to the field of computer systems. More particularly, a system and methods are provided for load balancing the transmission of packets through a communication interface among multiple transmit descriptor rings.

In traditional computing systems, an outgoing packet is formatted according to one or more higher layer protocols (e.g., IP—Internet Protocol, TCP—Transport Control Protocol) and then passed to a communication interface (e.g., a network interface card or NIC) by an interface device driver.

However, the transition from software handling (e.g., by upper layer protocols and the device driver) to hardware processing (e.g., in the communication interface) forms a chokepoint in the transmission process. In particular, typically only one packet at a time could be passed to the communication interface. This limitation is the result of having only one transmit descriptor ring for transferring packets to the interface. Regardless of how many packets the device driver may have to pass to the interface, only one descriptor, representing one packet, could be configured at a time.

Therefore, regardless of the number of processors in a computer system, or the data rate at which a communication interface could transmit packets, data transmission could be limited by the rate at which descriptors could be configured in the transmit descriptor ring. The communication interface may be able to transmit packets from a descriptor ring faster than packets could be placed on the ring.

Thus, there is a need for a system and method of passing multiple packets from a device driver to a communication interface at substantially the same time (e.g., in parallel).

### SUMMARY

In one embodiment of the invention, a system and method are provided for using multiple transmit descriptor rings to transfer packets from a computer system to a communication interface for transmission. In this embodiment, a device driver for a communication interface (e.g., a NIC) receives a packet (e.g., from an upper layer protocol), selects one of the rings and places the packet on the ring. Because the rings are managed in a mutually exclusive manner, packets can be placed on more than one ring at the same time (e.g., by different processors), thus allowing them to be populated in parallel, rather than serially.

In an embodiment of the invention, all packets in one communication connection (e.g., TCP flow) or all packets directed to one destination address or port may be placed on the same transmit ring.

### DESCRIPTION OF THE FIGURES

FIG. 1 is a block diagram depicting a system for passing packets to a communication interface via multiple transmit rings, in accordance with an embodiment of the present invention.

FIG. 2 is a block diagram demonstrating the management of multiple transmit descriptor rings, according to one embodiment of the invention.

FIG. 3 is a flowchart illustrating one method of load balancing outgoing packets among multiple transmit rings, in accordance with an embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

In one embodiment of the invention, a system and method are provided for load balancing the transfer of packets to a communication interface among multiple transmit descriptor rings. In this embodiment, a communication interface device driver is configured to place outbound packets having different destination addresses onto different transmit rings, for transmission by the interface, at substantially the same time. For example, in a computer system having multiple processors, each processor may simultaneously execute a thread or process for placing a packet onto a different transmit ring.

In different embodiments of the invention, outbound packets may be distributed among the multiple transmit rings based on different factors. In illustrative embodiments, the IP (Internet Protocol) address or TCP (Transmit Control Protocol) port of the destination of the packet may be used. More specifically, the device driver may calculate the modulo of a destination address or port over the number of transmit rings. Thus, all packets within a particular communication connection, or all packets to a particular destination, may be sent through the same transmit ring. This may help ensure that the packets are transmitted in the correct order.

One skilled in the art will appreciate that embodiments of the invention described herein eliminate congestion and delay that may occur from having all packets passed to a communication interface through a single transmit descriptor ring. In particular, the serial nature of populating one ring is replaced with the ability to populate multiple rings in parallel.

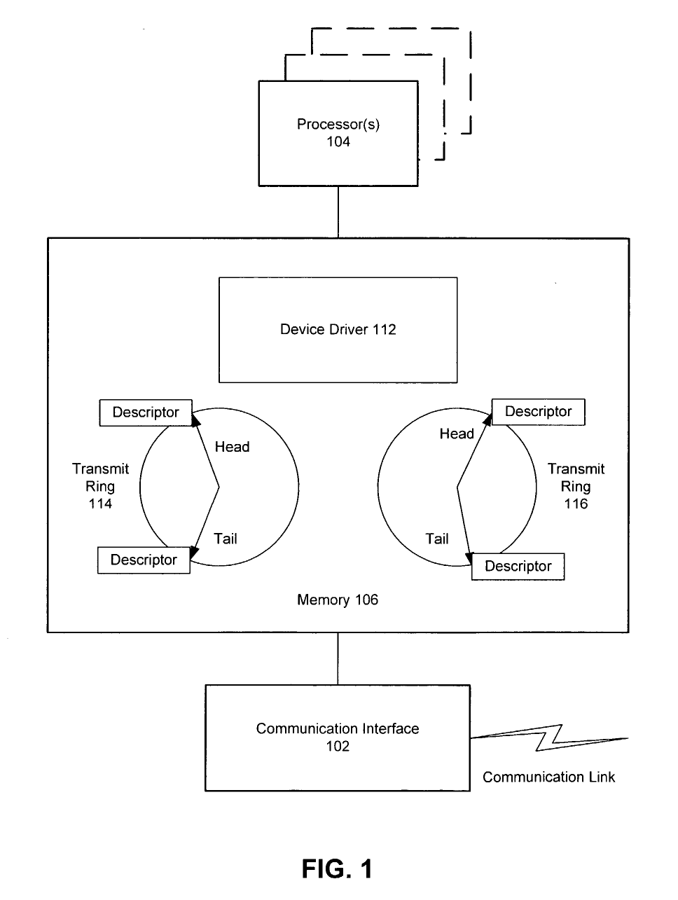

FIG. 1 is a block diagram of a computer system in which an embodiment of the invention may be implemented. The computer system of FIG. 1 includes communication interface 102, which may be a NIC (network interface card), HCA or TCA (Host Channel Adapter or Target Channel Adapter) or some other hardware device configured to transmit a packet onto a communication link. The communication link may be wired or wireless, and may be dedicated (e.g., point-to-point) or shared (e.g., a network, such as the Internet).

The computer system also includes one or more processors 104. Thus, the computer system may be an SMP (Symmetric Multi-Processor) computer. Communication interface 102 and processor(s) 104 are coupled to memory 106 (e.g., main memory).

Memory 106 comprises device driver 112 and two or more transmit descriptor rings—such as rings 114, 116. Device driver 112 is configured to be executed by processor(s) 104 to manage or control operation of communication interface 102. As described above, transmit rings 114, 116 facilitate the passage of outbound packets to communication interface 102 for transmission over a communication link. In different embodiments of the invention, different numbers of transmit rings may be employed.

When a packet is to be placed on either of rings 114, 116, only that ring needs to be locked. Thus, one processor or thread may be placing a packet on ring 114 while a different processor or thread places a different packet on ring 116. Parallel population of the rings may allow the communication interface to remove and transmit packets at a more efficient rate.

Management and scheduling of processes or threads for placing packets onto the rings may be handled by an operating system executed by processor(s) 112, such as Solaris® by Sun Microsystems, Inc. Illustratively, any thread may place a packet on any transmit ring or, alternatively, a thread may be limited to using a subset of all rings.

In one embodiment of the invention, the device driver or operating system includes a sequence of programming instructions for creating or instantiating a transmit descriptor ring. Thus, the process of preparing multiple rings is modular and differs from traditional systems in which a monolithic function or procedure was executed to allocate and map memory to set up both transmit and receive descriptor rings at one time.

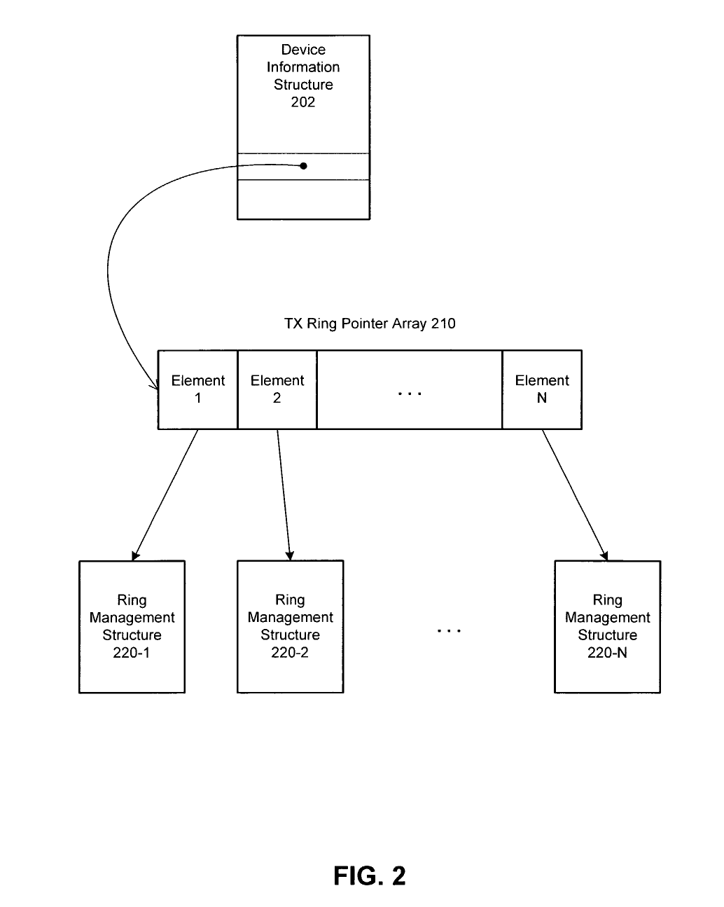

FIG. 2 depicts a structure for managing multiple transmit descriptor rings, according to one embodiment of the invention. In FIG. 2, device information structure 202 is maintained by a device driver for a communication interface, and may store various status and configuration information regarding the interface.

Device information structure 202 includes a pointer to TX ring pointer array 210, which contains an element or cell for each transmit descriptor ring established for transferring communications (e.g., packets) to the communication interface for transmission.

For each ring, a separate ring management structure 220 is instantiated and accessed through TX ring pointer array 210. Thus, for N rings, N management structures are created. As shown in FIG. 2, management of each ring can be performed independently of the other rings. As a result, when transmission processes or threads are being simultaneously executed on two processors, neither will interfere with the other.

In an embodiment of the invention, a mapping or initialization function for creating the rings is invoked during initialization of the communication interface's device driver. Illustratively, the mapping function allocates and initializes an individual transmit descriptor ring and therefore may be called once for each ring to be instantiated.

Another function for unmapping or tearing down a ring may be invoked during removal or reconfiguration of the device driver. This function would reverse the allocation (e.g., of memory) and initialization performed during the map function.

The following pseudo-code demonstrates an illustrative procedure for placing a packet onto one of a plurality of transmit descriptor rings:

ring_index=0/* assign default ring */

if (ip_packet)

{get tcp_port /* identify destination port */ ring_index=tcp_port% num_rings /* get ring index */ }

ring=device→tx_ring[ring_index]/* identify ring */

start(device, ring, mp) /* put packet on ring */

In this pseudo-code, the ring_ndex is an index into an array of pointers to, or identifiers of, the multiple transmit rings (e.g., TX ring pointer array 210 of FIG. 2). For each communication interface, a data structure is maintained by the device driver and includes or provides access to the array (e.g., device information structure 202 of FIG. 2). This structure is called “device” in the pseudo-code. The “start” function identifies the communication interface the packet is being provided to (e.g., via its device information data structure), the selected transmit ring (“ring”) and the packet (e.g., “mp” includes a pointer to the buffer containing the packet).

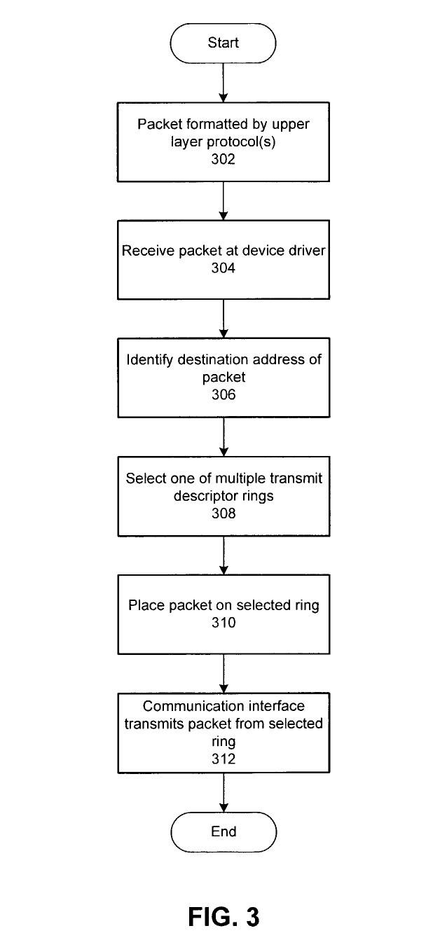

FIG. 3 demonstrates a method of using multiple transmit rings for the transmission of packets, according to one embodiment of the invention.

In operation 302, an outbound packet is formatted according to TCP and IP. In other embodiments of the invention, a packet may be formatted according one or more different upper layer protocols.

In operation 304, the packet is received at a device driver for a communication interface (e.g., a NIC) that will transmit the packet over a communication link (e.g., the Internet). The device driver may also receive other information, such as a destination address or a communication connection that includes the packet.

In operation 306, the device driver identifies a destination address/port of the packet. This identification may be made based on other information provided to the device driver in operation 304. Or, the device driver may parse the packet to access the desired address (or port). In this embodiment, the destination address corresponds to a protocol at layer three or higher of the packet's protocol stack.

In operation 308 the device driver selects one of multiple transmit rings, based on the destination address of the packet or the connection or flow that it belongs to. Illustratively, the driver calculates a hash of the destination address or computes the modulo of the packet's destination address over the number of transmit rings (e.g., destination address MOD number of rings). Therefore, in this embodiment of the invention, the same transmit ring may be selected for all packets sent to the same destination address, or all packets within one communication connection.

For any packet not formatted according to a predetermined set of protocols (e.g., TCP and IP), a default ring may be selected.

In operation 310, the packet is placed on the selected ring. This may entail configuring a descriptor within the ring to identify a buffer in which the packet is stored. This may also involve the translation or mapping of the buffer from a virtual address to an input/output (e.g., physical) address understood by the communication interface. Because there are multiple transmit rings, different packets may be placed on different rings simultaneously or nearly simultaneously.

In operation 312, the communication interface takes the packet and transmits it over a communication link. The illustrated method then ends.

In the embodiment of the invention depicted in FIG. 3, the communication interface treats each transmit ring with the same priority. Thus, it may transmit packets from the rings in a round-robin or other fair scheme. Similarly, the device driver may view each transmit ring as having the same priority, so that packets (or communication connections) may be relatively evenly distributed among the rings.

Although packets or connections are distributed among the multiple transmit rings on the basis of their destination addresses in the embodiment of FIG. 3, in other embodiments of the invention, other means of selecting a ring may be used. For example, a timestamp, checksum or other characteristic of a connection or the first packet of a connection may be hashed to identify a ring for all packets within the connection.

The foregoing embodiments of the invention have been presented for purposes of illustration and description only. They are not intended to be exhaustive or to limit the invention to the forms disclosed. Accordingly, the scope of the invention is defined by the appended claims, not the preceding disclosure.

What Is Claimed Is:

1. A method of transmitting packets, comprising:
receiving a packet addressed to a destination address;
based on the destination address, selecting one of a plurality of transmit rings; and
placing the packet on the selected transmit ring for transmission by a communication interface.

2. The method of claim 1, further comprising:
removing the packet from the selected transmit ring; and
transmitting the packet over a communication link.

3. The method of claim 2, wherein said removing and transmitting are performed by a communication interface.

4. The method of claim 1, wherein said receiving, selecting and placing are performed by a device driver configured to manage operation of the communication interface.

5. The method of claim 1, wherein said receiving comprises:
receiving a packet, from a higher layer protocol, at a device driver for the communication interface.

6. The method of claim 5, further comprising:
at the communication interface, transferring the packet from the selected transmit ring onto a communication link.

7. The method of claim 1, wherein said selecting comprises:
calculating a modulo of the destination address over the number of transmit rings.

8. The method of claim 1, further comprising:
parsing the packet to retrieve the destination address.

9. The method of claim 1, further comprising:
receiving the destination address from a higher layer protocol.

10. The method of claim 1, wherein said placing comprises:
placing different packets on different transmit rings at substantially the same time.

11. The method of claim 1, further comprising:
placing all subsequent packets in the same connection as the packet onto the same transmit ring.

12. A computer readable storage medium storing instructions that, when executed by a computer, cause the computer to perform a method of transmitting packets, the method comprising:
receiving a packet addressed to a destination address;
based on the destination address, selecting one of a plurality of transmit rings; and
placing the packet on the selected transmit ring for transmission by a communication interface.

13. A method of load balancing the transmission of packets among multiple transmit rings, comprising:
at a device driver for a communication interface of a computer system, receiving packets to be transmitted to different destination addresses;
for each packet:
selecting one of a plurality of transmit rings based on the destination address of the packet; and
placing the packet onto the selected transmit ring; and
at the communication interface, transmitting the packets over a communication link.

14. The method of claim 13, wherein said selecting comprises:
calculating a modulo of a destination address of the packet over the number of transmit rings.

15. The method of claim 13, wherein said placing comprises:
placing a first packet having a first destination address onto a first transmit ring and placing a second packet having a second destination address onto a second transmit ring at substantially the same time.

16. The method of claim 13, further comprising, for each packet:
parsing the packet to identify its destination address.

17. The method of claim 13, further comprising:
receiving the destination addresses from a higher layer protocol.

18. The method of claim 13, wherein the destination addresses are IP (Internet Protocol) destination addresses.

19. The method of claim 13, wherein the destination addresses are TCP (Transport Control Protocol) destination ports.

20. A computer readable storage medium storing instructions that, when executed by a computer, cause the computer to perform a method of load balancing the transmission of packets among multiple transmit rings, the method comprising:
at a device driver for a communication interface of a computer system, receiving packets to be transmitted to different destination addresses;
for each packet:
selecting one of a plurality of transmit rings based on the destination address of the packet; and
placing the packet onto the selected transmit ring; and
at the communication interface, transmitting the packets over a communication link.

21. A computer system, comprising:
a memory;
within the memory, a plurality of transmit rings for facilitating transmission of packets from the computer system;
a communication interface configured to transmit packets from the transmit rings over a communication link; and
a device driver configured to, for each of the packets:
identify a destination address of the packet;
based on the destination address, select one of the transmit rings; and
place the packet on the selected transmit ring.

22. The computer system of claim 21, further comprising:
a plurality of processors.

23. The computer system of claim 22, wherein each of the processors is configured to place a different packet on a different transmit ring at substantially the same time.

24. The computer system of claim 21, wherein the device driver is configured to place packets on more than one of the transmit rings at substantially the same time.

25. The computer system of claim 21, wherein the device driver selects one of the plurality of transmit rings by calculating a modulo of the destination address over the number of transmit rings.

26. The computer system of claim 21, wherein the device driver is configured to select the same transmit ring for all packets of one communication connection between the computer system and the destination address.

27. The computer system of claim 21, wherein the device driver is configured to select the same transmit ring for all packets transmitted to the destination address.

28. The computer system of claim 21, wherein the communication interface is configured to transmit packets from the plurality of transmit rings in a round-robin order.

29. The computer system of claim 21, wherein the device driver identifies the destination address of the packet by parsing the packet.

30. The computer system of claim 21, wherein the device driver identifies the destination address of the packet by receiving the destination address from a higher layer protocol.

31. The computer system of claim 21, wherein the destination address is one of an IP (Internet Protocol) destination address and a TCP (Transport Control Protocol) destination port.
